(19) United States
(12) Patent Application Publication
(10) Pub. No.: US 2005/0106412 A1
(43) Pub. Date: May 19, 2005

(54) Doped lithium quinolate

(76) Inventor: Poopathy Kathirgamanathan, North Harrow (GB)

Correspondence Address: Andover IP Law, Suite 300, 44 Park Street, Andover, MA, 01810, US

(21) Appl. No.: 10/496,416

(22) PCT Filed: Nov. 22, 2002
(86) PCT No.: PCT/GB02/05268

(30) Foreign Application Priority Data
Nov. 23, 2001 (GB) 0128074.2

(51) Int. Cl. H05B 33/14; C09K 11/06

(52) U.S. Cl. 428/690; 428/917; 313/504; 313/506; 252/301.16; 257/102

(57) ABSTRACT

An electroluminescent device has a doped lithium quinolate as the compound forming the electroluminescent material.

The present invention relates to electroluminescent devices and displays.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04028, PCT/GB00/00268 describe electroluminescent complexes, structures and devices using rare earth chelates.

Patent Application WO 00/32717 discloses the use of lithium quinolate as an electroluminescent material in electroluminescent devices. Lithium quinolate has greater electron mobility, of the order of 45% than the widely used aluminium quinolate and aluminium quinolate derivatives which can make it a more effective electroluminescent material.

An article by C. Schmitz, H Scmidt and M. Thekalakat entitled Lithium Quinolate Complexes as Emitter and Interface Materials in Organic Light-Emitting Diodes in Chem. Mater, 2000, 12, 3012-3019 discloses the use of a layer of lithium quinolate together with hole transporting materials in electroluminescent devices.

We have now found that using doped lithium quinolate compositions as an electroluminescent material in electroluminescent devices gives an improved performance.

According to the invention there is provided an electroluminescent device which comprises sequentially (i) a first electrode (ii) a layer of an electroluminescent material which comprises lithium quinolate doped with a dopant and (iii) a second electrode.

The invention also provides a composition which comprises lithium quinolate incorporating a dopant.

The preferred dopants are coumarins such as those of formula 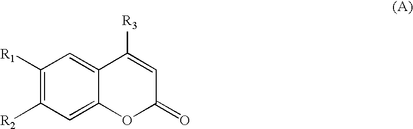
where R₁, R₂, and R₃ are hydrogen or an alkyl group such as a methyl or ethyl group, amino and substituted amino groups e.g. 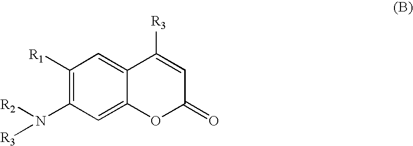
   where R₃ is hydrogen or alkyl group such as a methyl or ethyl group,

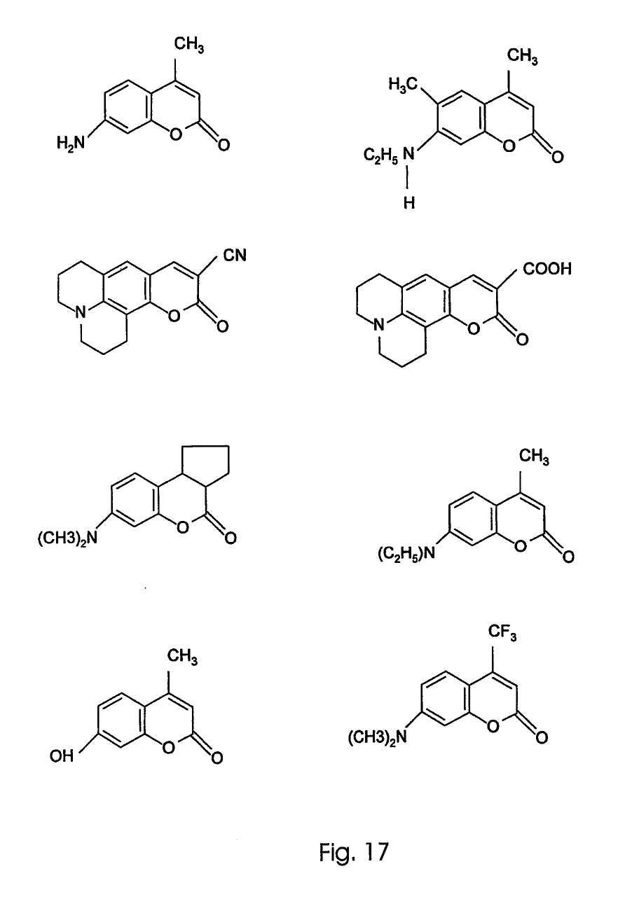

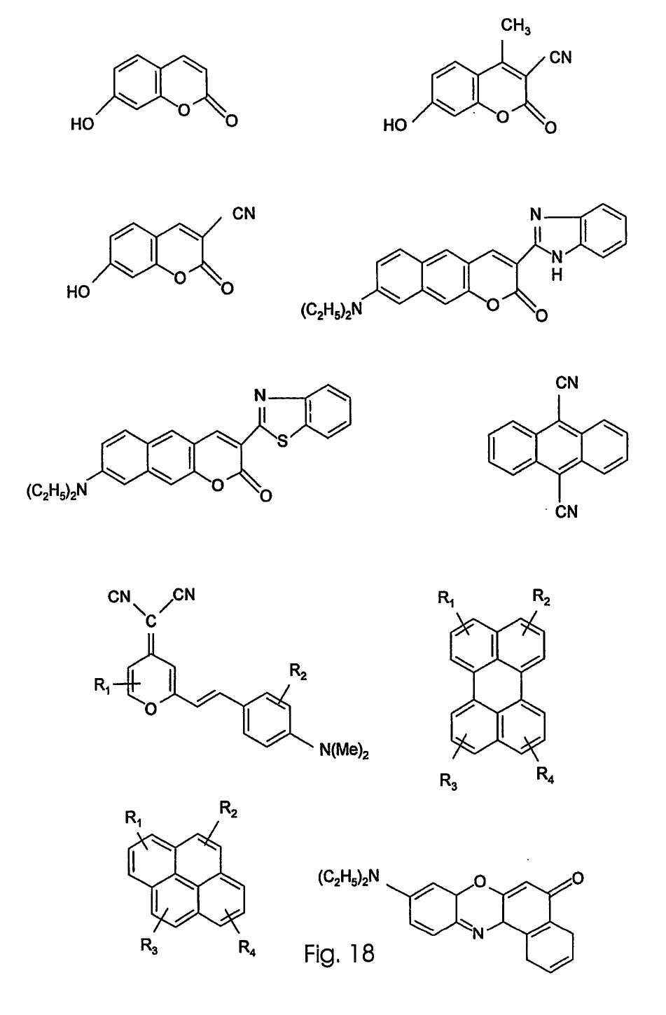

Examples of coumarins are given in FIGS. 17 and 18 of the drawings.

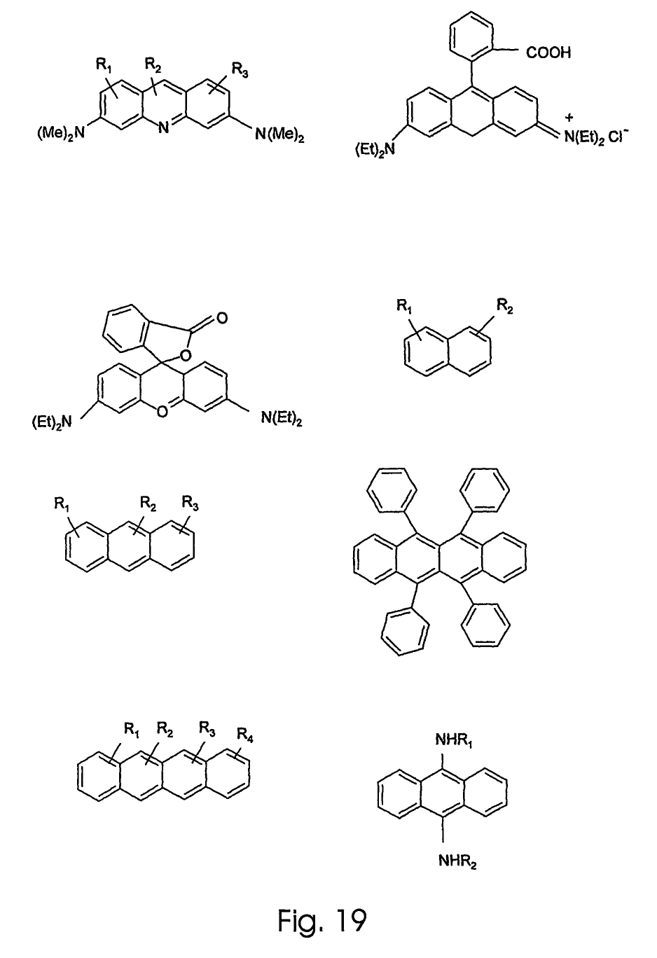

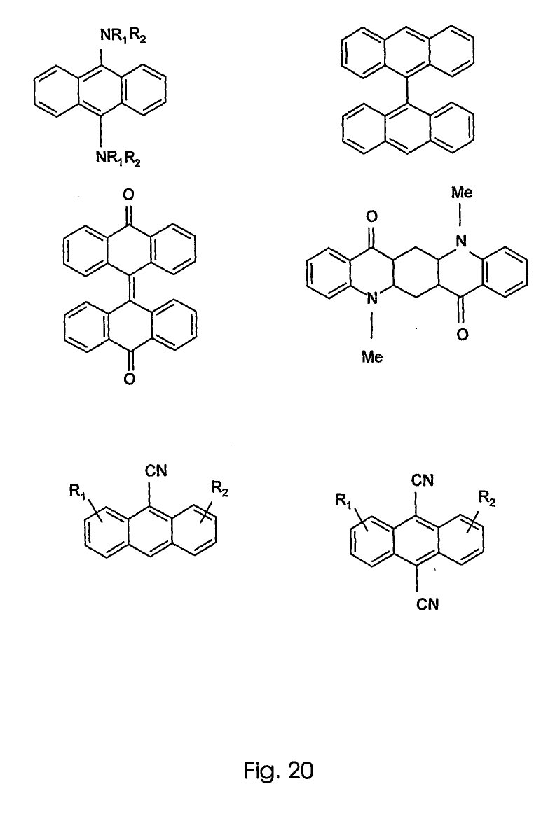

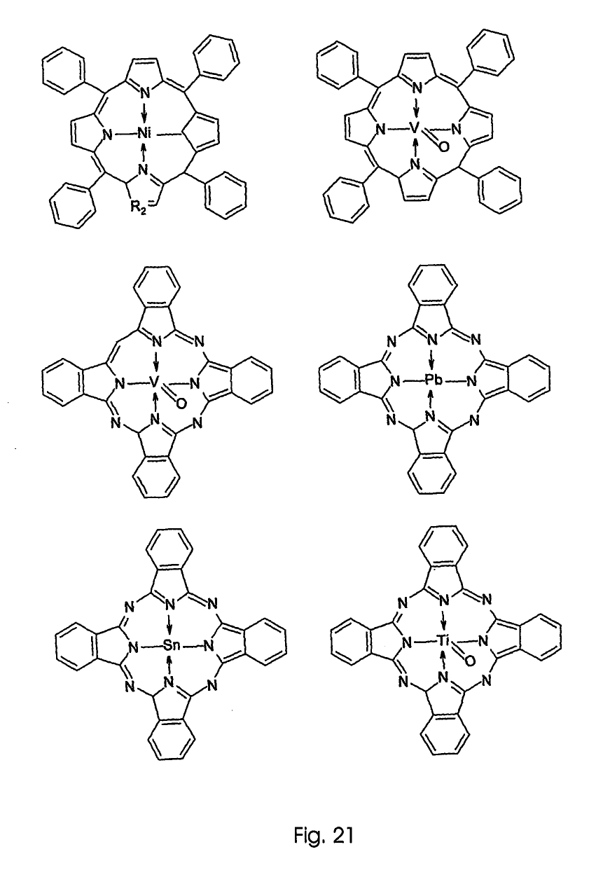

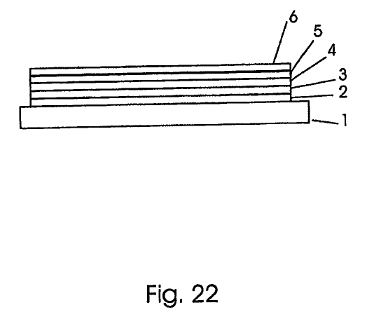

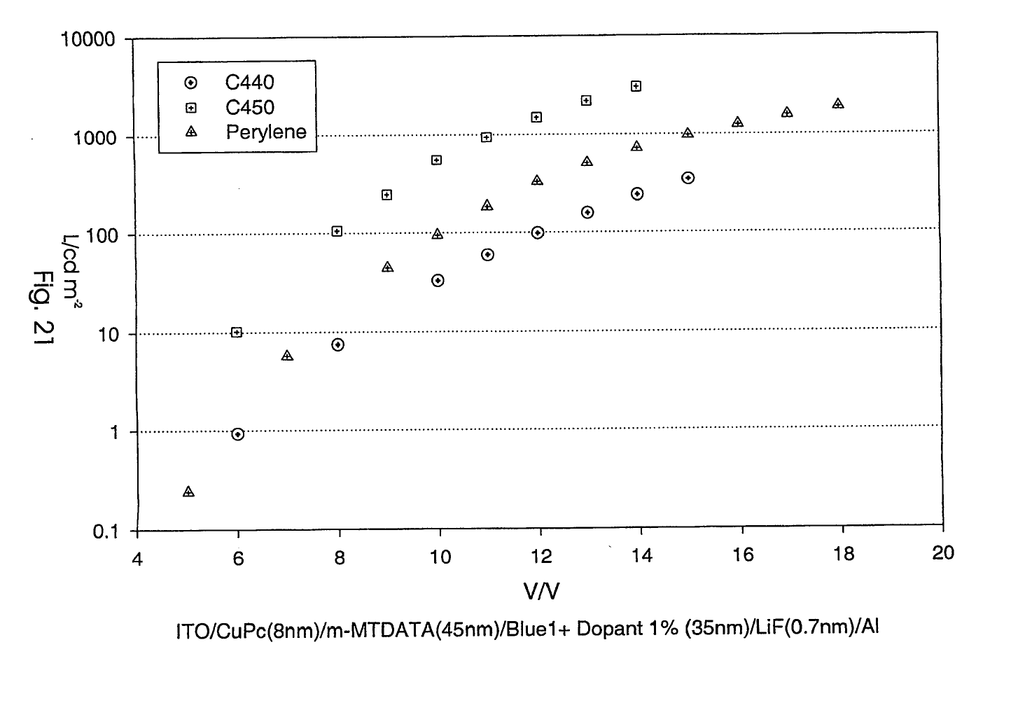

Other dopants include salts of bis benzene sulphonic acid such as 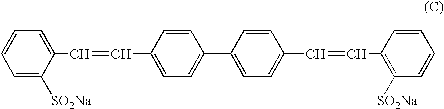
and perylene and perylene derivatives and dopants of the formulae of FIGS. 19 to 21 of the drawings where R₁, R₂, R₃ and R₄ are R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups
—C—CH₂═CH₂—R
where R is as above.

Other dopants which can be used are organometallic complexes such as those of general formula (Lα)ₙM where M is a rare earth, lanthanide or an actinide, Lα is an organic complex and n is the valence state of M.

Other dopant compounds which can be used in the present invention are of formula 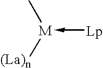
where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . . . )M (Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . . ) is equal to the valence state of the metal M. Where there are 3 groups Lα which corresponds to the III valence state of M the complex has the formula (L₁)(L₂)(L₃)M (Lp) and the different groups (L₁)(L₂)(L₃) may be the same or different.

Lp can be monodentate, bidentate or polydentate and there can be one or more ligands Lp.

Preferably M is metal ion having an unfilled inner shell and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III), Er(III), Yb(III) and more preferably Eu(III), Tb(III), Dy(III), Gd (III), Er (III), Yt(III).

Further dopant compounds which can be used in the present invention are complexes of general formula (Lα)ₙM₁M₂ where M₁ is the same as M above, M₂ is a non rare earth metal, Lα is a as above and n is the combined valence state of M₁ and M₂. The complex can also comprise one or more neutral ligands Lp so the complex has the general formula (Lα)ₙ M₁ M₂ (Lp), where Lp is as above. The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium, titanium, vanadium, zirconium, tantalum, molybdenum, rhodium, iridium, titanium, niobium, scandium, yttrium.

For example (L₁)(L₂)(L₃)(L . . . )M (Lp) where M is a rare earth, transition metal, lanthanide or an actinide and (L₁)(L₂)(L₃)(L . . . ) and (Lp) are the same or different organic complexes.

Further organometallic complexes which can be used as dopants in the present invention are binuclear, trinuclear and polynuclear organometallic complexes e.g. of formula 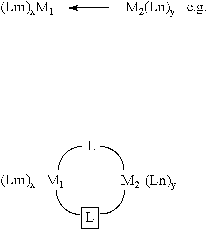
where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula
(Lm)ₓM₁-M₃ (Ln)_{y}-M₂(Lp)_{z}
or 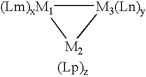
where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group.

For example the metals can be linked by bridging ligands e.g. 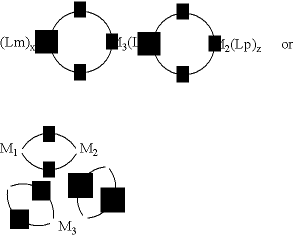
where L is a bridging ligand.

By polynuclear is meant there are more than three metals joined by metal to metal bonds and/or via intermediate ligands 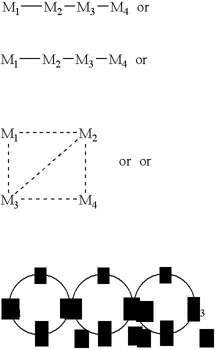
where M₁, M₂, M₃ and M₄ are rare earth metals and L is a bridging ligand.

Preferably Lα is selected from β diketones such as those of formulae 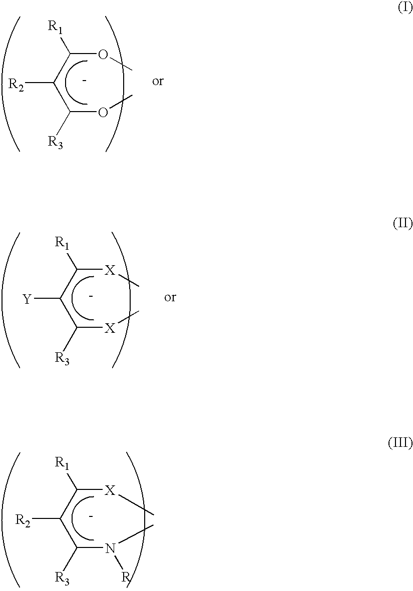
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups Lα may also be the same or different charged groups such as carboxylate groups so that the group L₁ can be as defined above and the groups L₂, L₃ . . . can be charged groups such as 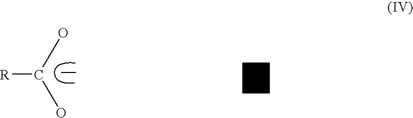
where R is R₁ as defined above or the groups L₁, L₂ can be as defined above and L₃ . . . etc. are other charged groups.

R₁, R₂ and R₃ can also be 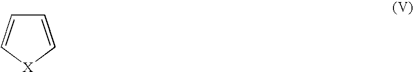
where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups Lα may be the same or different ligands of formulae 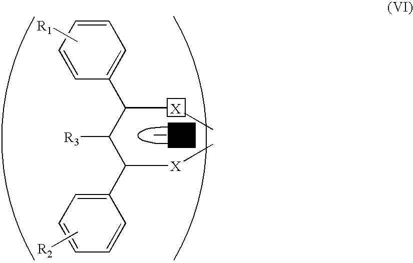
where X is O, S, or Se and R₁ R₂ and R₃ are as above.

The different groups Lα may be the same or different quinolate derivatives such as 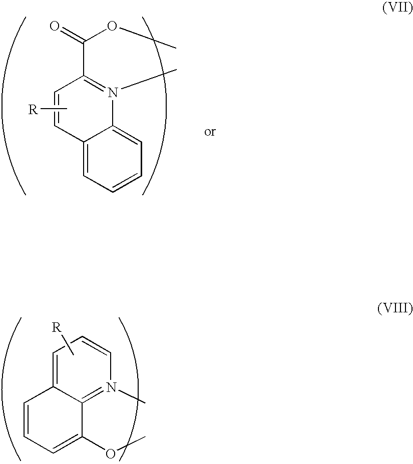
where R is hydrocarbyl, aliphatic, aromatic or heterocyclic carboxy, aryloxy, hydroxy or alkoxy e.g. the 8 hydroxy quinolate derivatives or 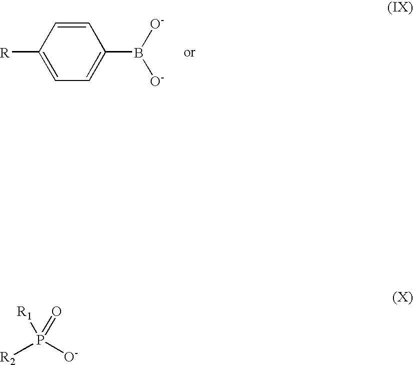
where R, R₁, and R₂ are as above or are H or F e.g. R₁ and R₂ are alkyl or alkoxy groups

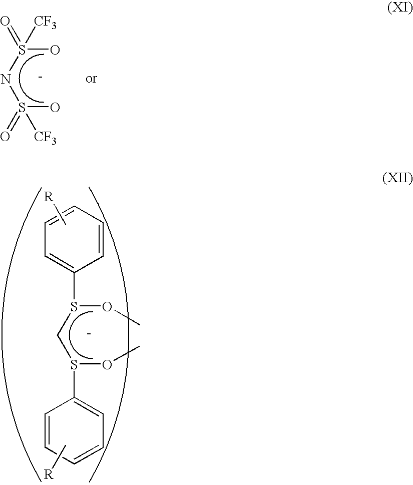

As stated above the different groups Lα may also be the same or different carboxylate groups e.g. 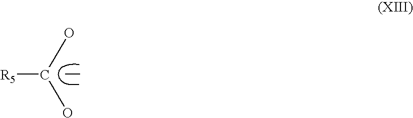
where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be 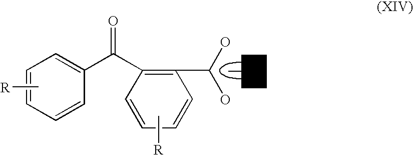
where R is as above e.g. alkyl, allenyl, amino or a fused ring such as a cyclic or polycyclic ring.

The different groups Lα may also be 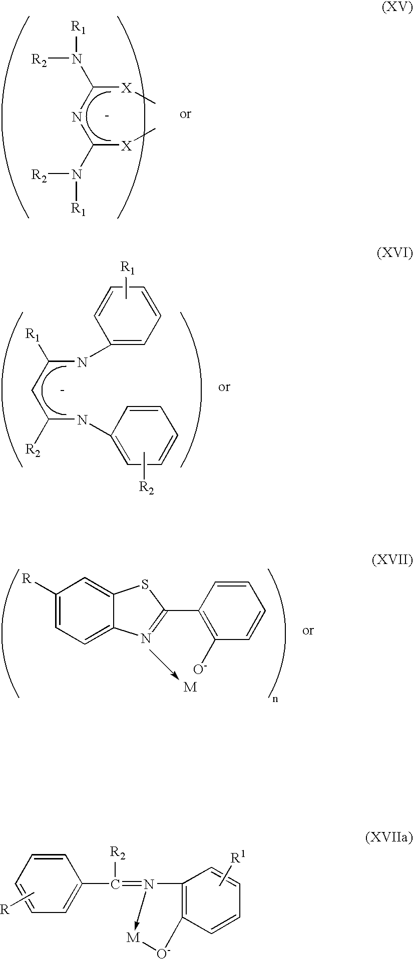
Where R, R₁ and R₂ are as above.

Examples of β-diketones which are preferably used with non rare earth chelates are tris-(1,3-diphenyl-1-3-propanedione) (DBM) and suitable metal complexes are Al(DBM)₃, Zn(DBM)₂ and Mg(DBM)₂, Sc(DBM)₃ etc.

A preferred β-diketone is when R₁ and/or R₃ are alkoxy such as methoxy and the metals are aluminium or scandium i.e. the complexes have the formula 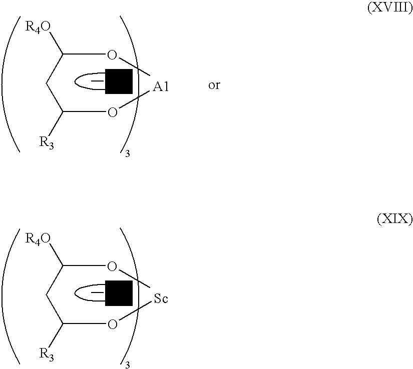
where R₄ is an alkyl group, preferably methyl and R₃ is hydrogen, an alkyl group such as methyl or R₄O.

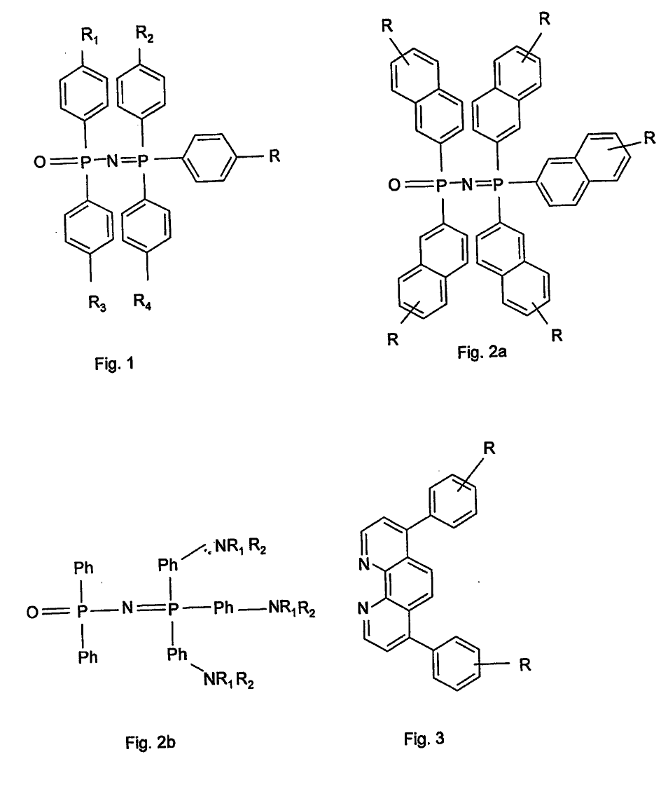

The groups Lₚ in the formula (A) above can be selected from 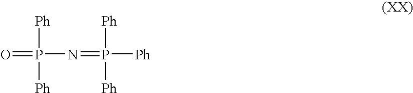
Where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups
—C—CH₂═CH₂-R
where R is as above.

Lp can also be compounds of formulae 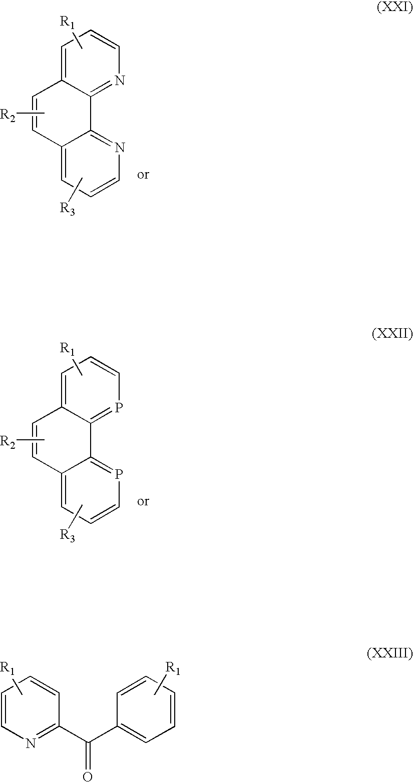
where R₁, R₂ and R₃ are as referred to above, for example bathophen shown in FIG. 3 of the drawings in which R is as above or 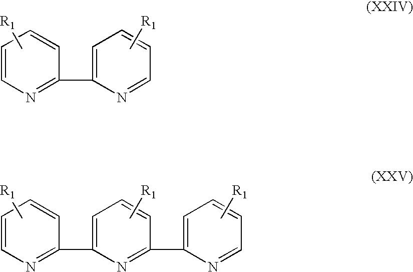
where R₁, R₂ and R₃ are as referred to above.

Lₚ can also be 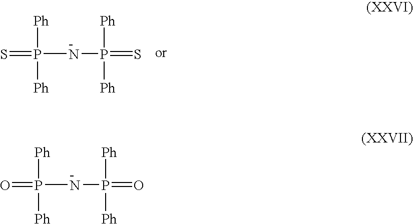
where Ph is as above.

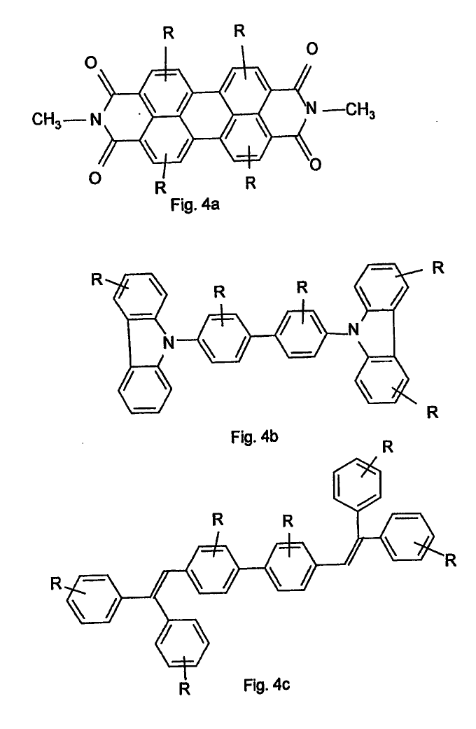

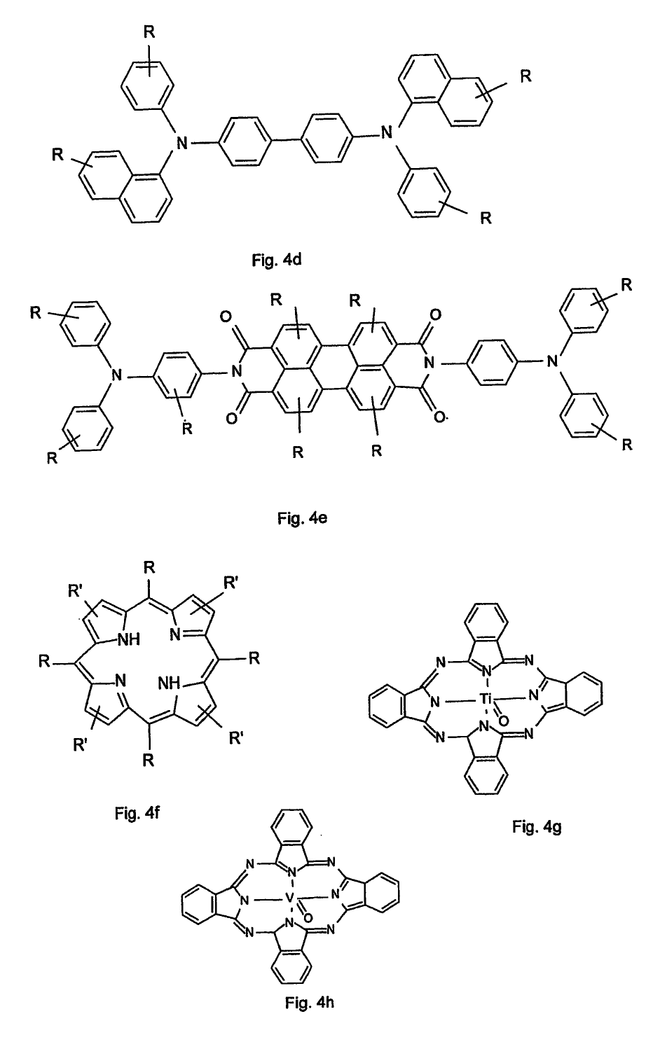

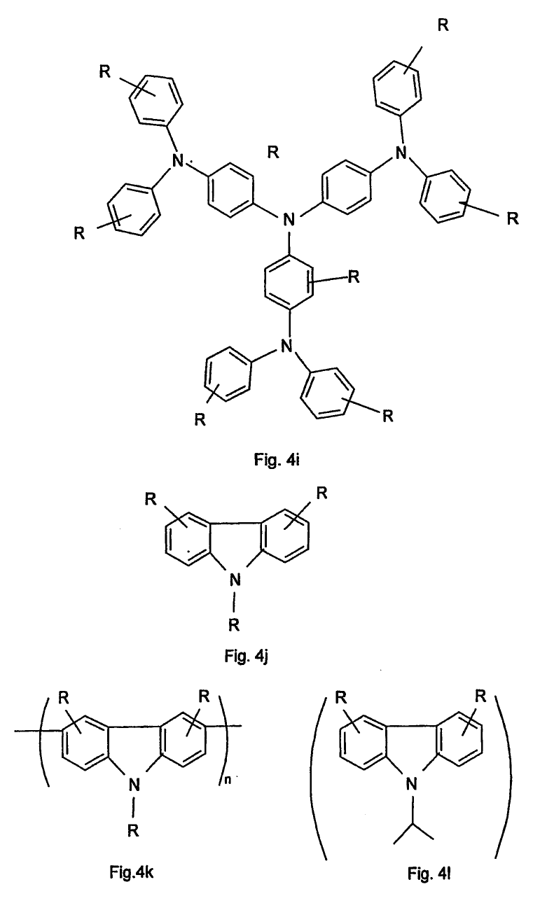

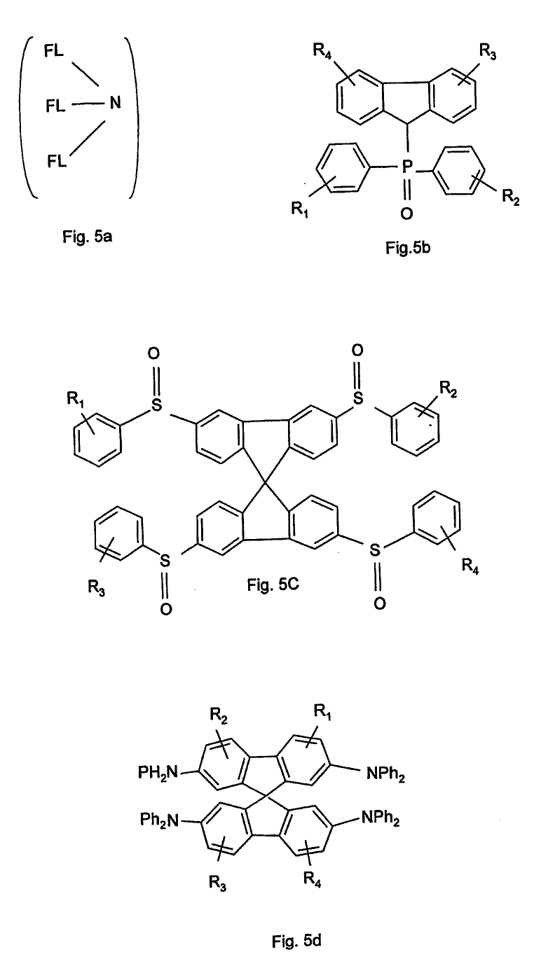

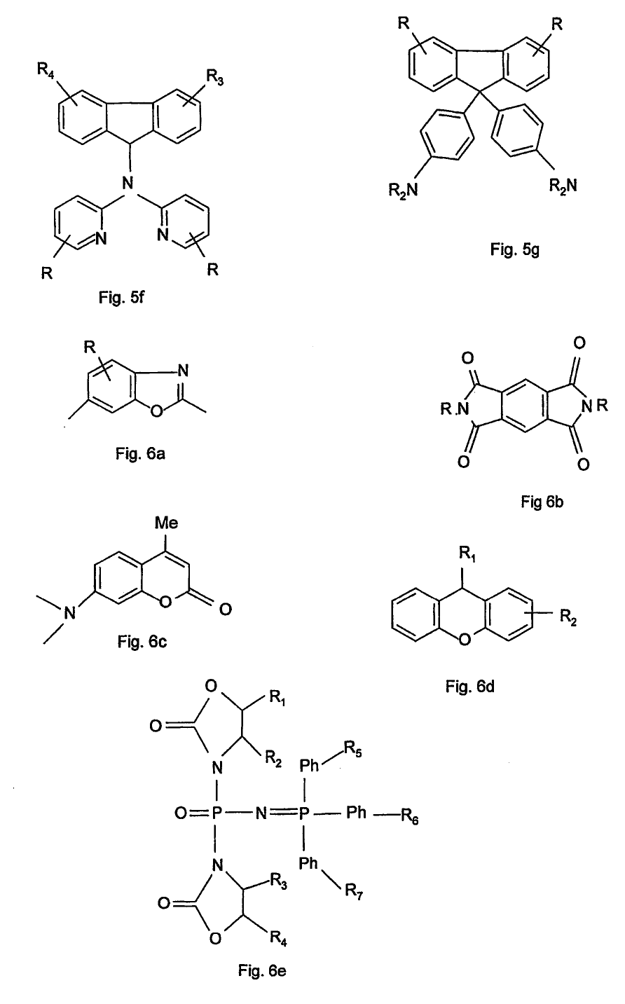

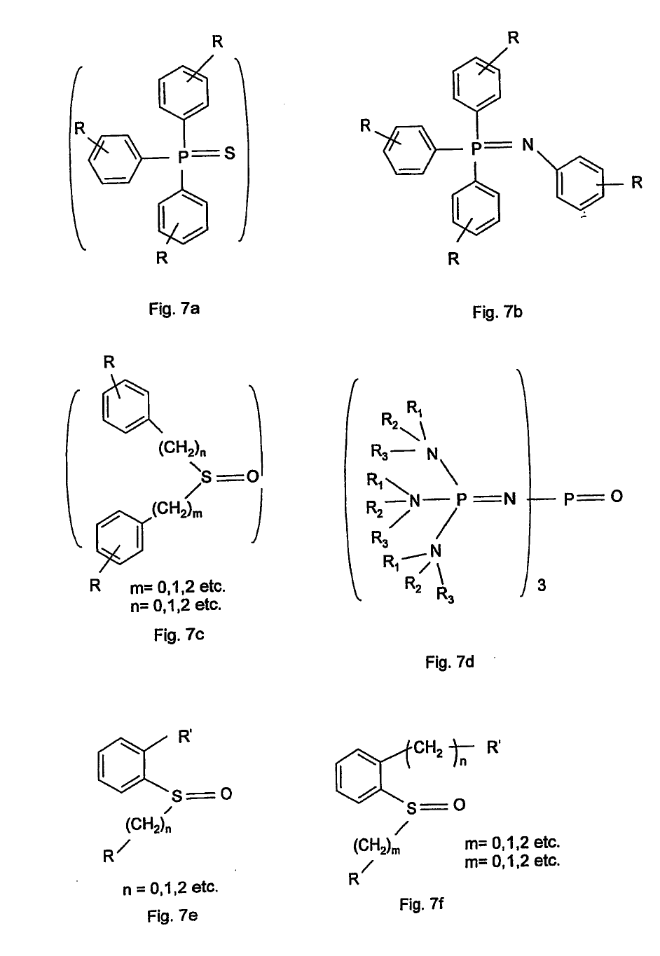

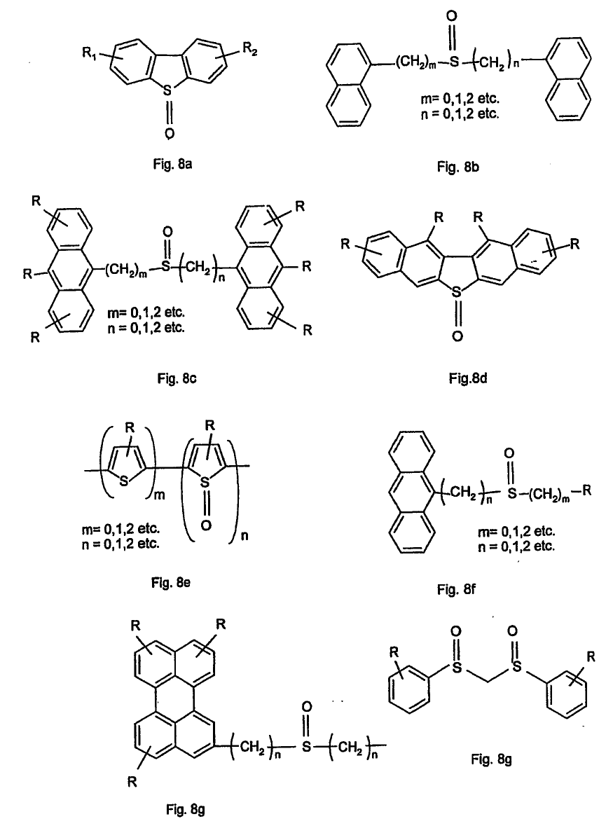

Other examples of Lₚ chelates are as shown in FIG. 4 and fluorene and fluorene derivatives e.g. a shown in FIG. 5 and compounds of formulae as shown as shown in FIGS. 6 to 8.

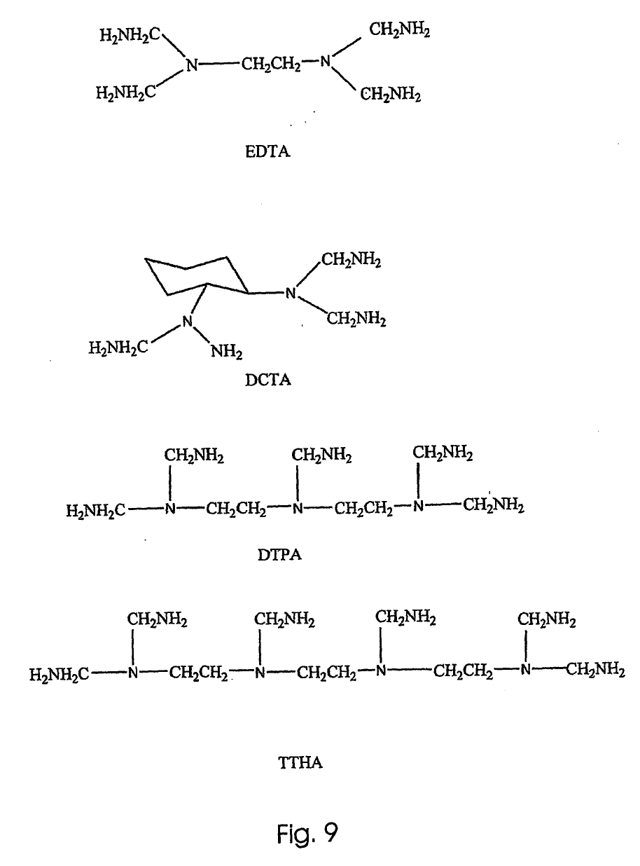

Specific examples of Lα and Lp are tripyridyl and TMHD, and TMHD complexes, α, α′, α″ tripyridyl, crown ethers, cyclans, cryptans phthalocyanans, porphoryins ethylene diamine tetramine (EDTA), DCTA, DTPA and TTHA. Where TMHD is 2,2,6,6-tetramethyl-3,5-heptanedionato and OPNP is diphenylphosphonimide triphenyl phosphorane. The formulae of the polyamines are shown in FIG. 9.

The dopant is preferably present in the lithium quinolate in an amount of 0.01% to 5% by weight and more preferably in an amount of 0.01% to 2%.

The doped lithium quinolate can be deposited on the substrate directly by vacuum evaporation of a mixture of the lithium quinolate and dopant or evaporation from a solution in an organic solvent or by co evaporation of the lithium quinolate and dopant. The solvent which is used will depend on the material but chlorinated hydrocarbons such as dichloromethane and n-methylpyrrolidone; dimethyl sulphoxide; tetrahydrofuran; dimethylformamide etc. are suitable in many cases.

Alternatively doped lithium quinolate can be deposited by spin coating of the lithium quinolate and dopant from solution, or by vacuum deposition from the solid state e.g. by sputtering, by melt deposition of a mixture of the lithium quinolate and the dopant etc. or any other conventional method.

The lithium quinolate is preferably made by the reaction of a lithium alkyl or alkoxide with 8-hydroxy quinoline or substituted 8-hydroxy quinoline in a solution in a solvent which comprises acetonitrile and more preferably by the reaction of 8-hydroxyquinoline with butyl lithium in a solvent containing acetonitrile, the solvent can be acetonitrile or a mixture of acetonitrile with another liquid such as toluene.

In the electroluminescent devices of the present invention the first electrode is preferably a transparent substrate such as a conductive glass or plastic material which acts as the anode, preferred substrates are conductive glasses such as indium tin oxide coated glass or indium zinc oxide coated glass, but any glass which is conductive or has a transparent conductive layer such as a metal or conductive polymer can be used. Conductive polymers and conductive polymer coated glass or plastics materials can also be used as the substrate.

Preferably there is a hole transporting layer deposited on the transparent substrate and the doped lithium quinolate is deposited on the hole transporting layer. The hole transporting layer serves to transport holes and to block the electrons, thus preventing electrons from moving into the electrode without recombining with holes. The recombination of carriers therefore mainly takes place in the emitter layer.

The hole transporting layer can be made of a film of an aromatic amine complex such as poly(vinylcarbazole), N,N′-diphenyl-N,N′-bis(3-methylphenyl)-1,1′-biphenyl-4,4′-diamine (TPD), polyaniline, substituted polyanilines, polythiophenes, substituted polythiophenes, polysilanes etc. Examples of polyanilines are polymers of 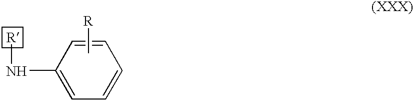
where R is in the ortho- or meta-position and is hydrogen, C1-18 alkyl, C1-6 alkoxy, amino, chloro, bromo, hydroxy or the group 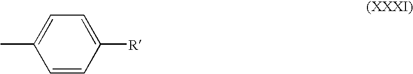
   where R is alky or aryl and R′ is hydrogen, C1-6 alkyl or aryl with at least one other monomer of formula I above.

Polyanilines which can be used in the present invention have the general formula 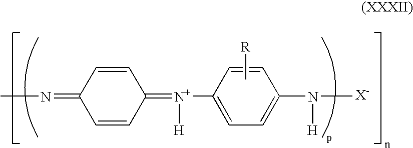
where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulosesulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate, an example of an arenedicarboxylate is phthalate and an example of arenecarboxylate is benzoate.

Preferred copolymers are the copolymers of aniline with o-anisidine, m-sulphanilic acid or o-aminophenol, or o-toluidine with o-aminophenol, o-ethylaniline or o-phenylene diamine.

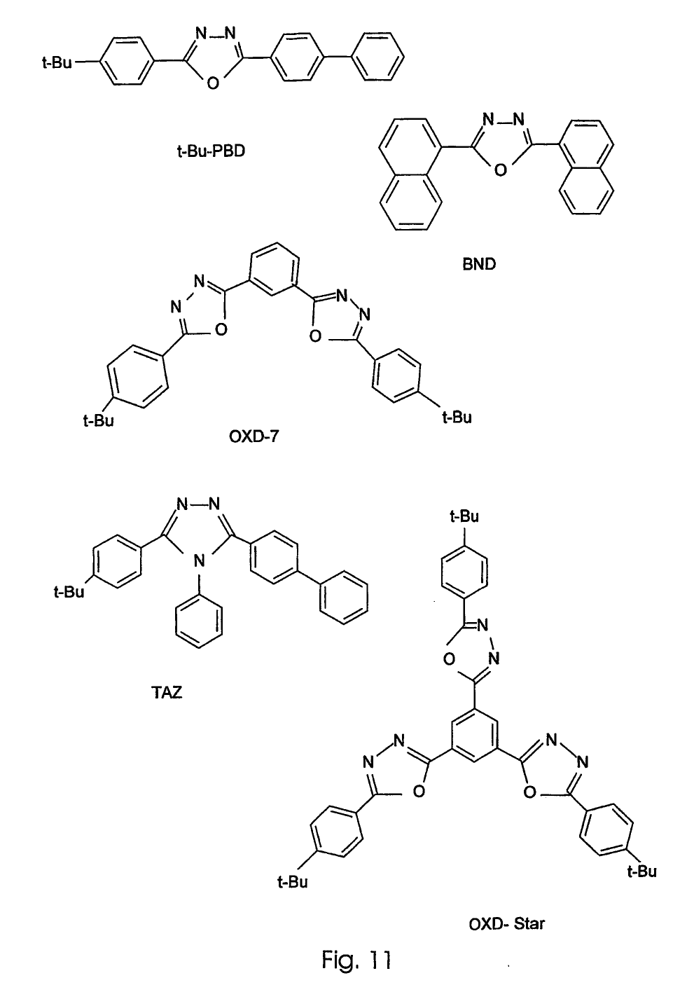

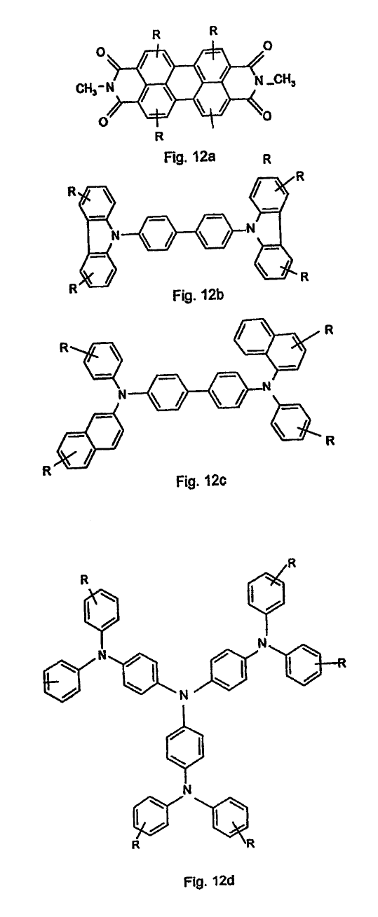

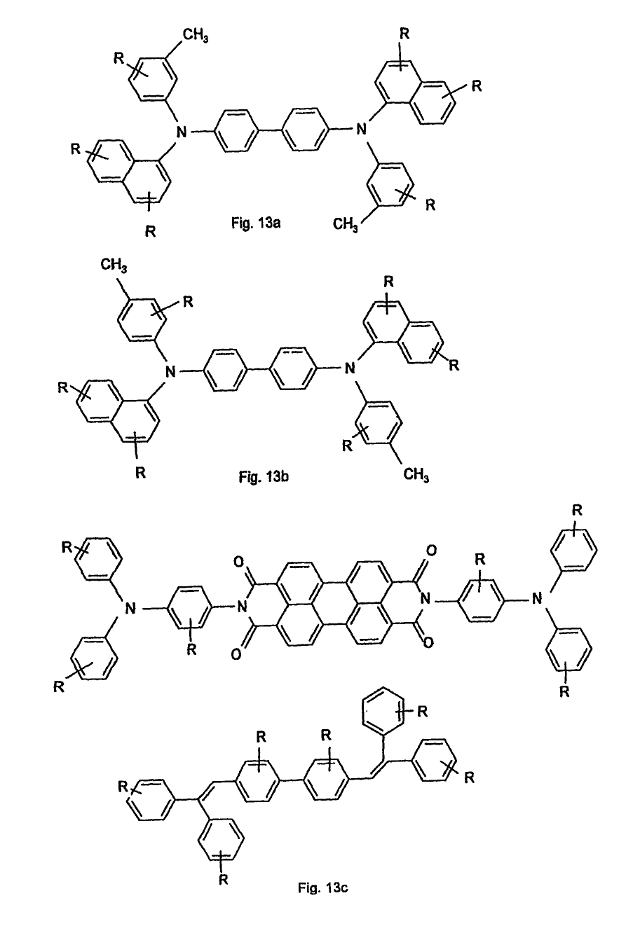

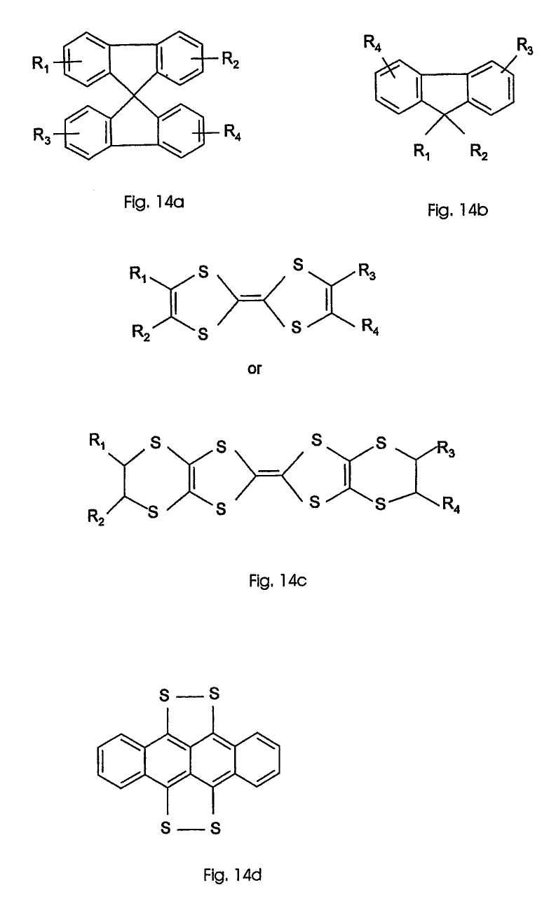

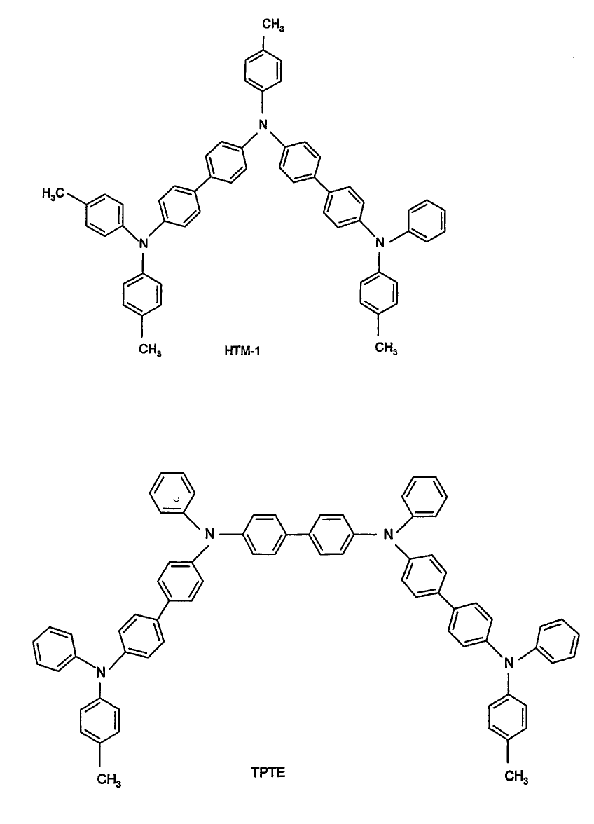

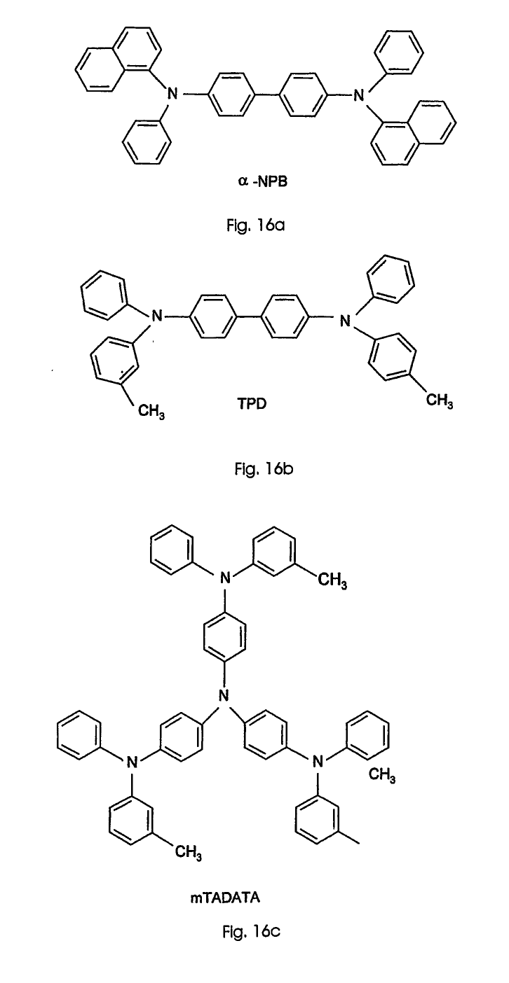

The structural formulae of some other hole transporting materials are shown are shown in FIGS. 11, 12, 13, and 14 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

The hole transporting material and the doped lithium quinolate can be mixed to form one layer e.g. in an proportion of 5 to 95% of the hole transporting material to 95 to 5% of the light emitting metal compound.

There can be a buffer layer such as a layer of copper phthalocyanine or a polymer of a cyclic aromatic compound such as a polyaniline between the anode and the layer of the hole transporting material.

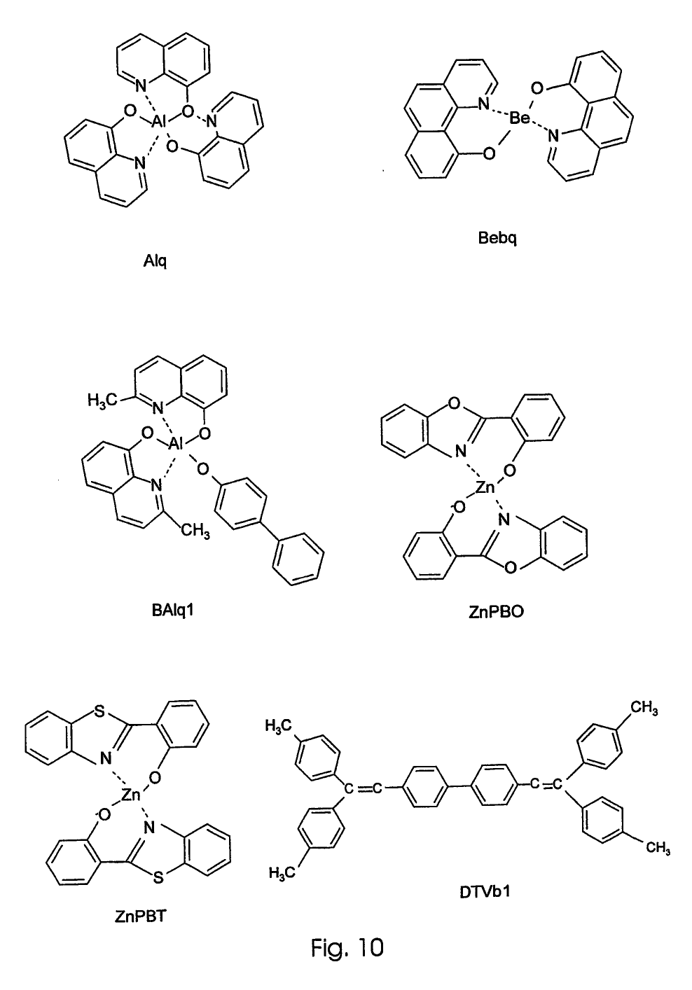

Optionally there is a layer of an electron transporting material between the cathode and the doped lithium quinolate layer, the electron transporting material is a material which will transport electrons when an electric current is passed through electron transporting materials include a metal complex such as a metal quinolate e.g. an aluminium quinolate, lithium quinolate, a cyano anthracene such as 9,10 dicyano anthracene, a polystyrene sulphonate and compounds of formulae shown in FIG. 10. Instead of being a separate layer the electron transporting material can be mixed with the doped lithium quinolate to form one layer e.g. in a proportion of 5 to 95% of the electron transporting material to 95 to 5% of the light emitting metal compound.

The electroluminescent layer can comprise a mixture of the doped lithium quinolate with the hole transporting material and electron transporting material.

The second electrode functions as the cathode and can be any low work function metal e.g. aluminium, calcium, lithium, silver/magnesium alloys etc., aluminium is a preferred metal. Transparent cathodes can be used formed of a transparent layer of a metal on a glass substrate and light will then be emitted through the cathode. A transparent electrode which has a suitable work function, for example by a indium zinc oxide coated glass in which the indium zinc oxide has a low work function. The anode can have a transparent coating of a metal formed on it to give a suitable work function.

Either or both electrodes can be formed of silicon and the electroluminescent material and intervening layers of a hole transporting and electron transporting materials can be formed as pixels on the silicon substrate. Preferably each pixel comprises at least one layer of a rare earth chelate electroluminescent material and an (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work function, for example by a indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers, for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is converted to an analogue signal in each pixel circuit. The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metal-oxide-semiconductor field effect transistors (MOSFETs) or by an active matrix transistor.

The invention is described in the examples.

### EXAMPLE 1

Preparation of Lithium Quinolate

2.32 g (0.016 mole) of 8-hydroxyquinoline was dissolved in acetonitrile and 10 ml of 1.6M n-butyl lithium (0.016 mole) was added. The solution was stirred at room temperature for one hour and an off white precipitate filtered off. The precipitate was washed with water followed by acetonitrile and dried in vacuo. The solid was shown to be lithium quinolate.

### EXAMPLE 2

The lithium quinolate prepared as in example 1 was mixed with a dopant the dopants used were 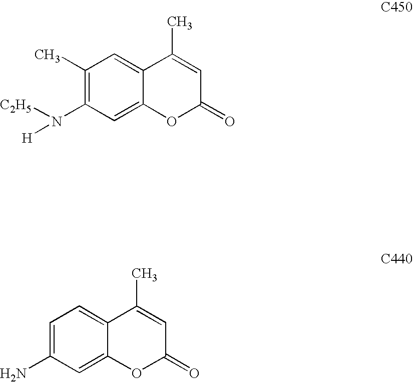
and perylene

### EXAMPLE 3

Device Fabrication

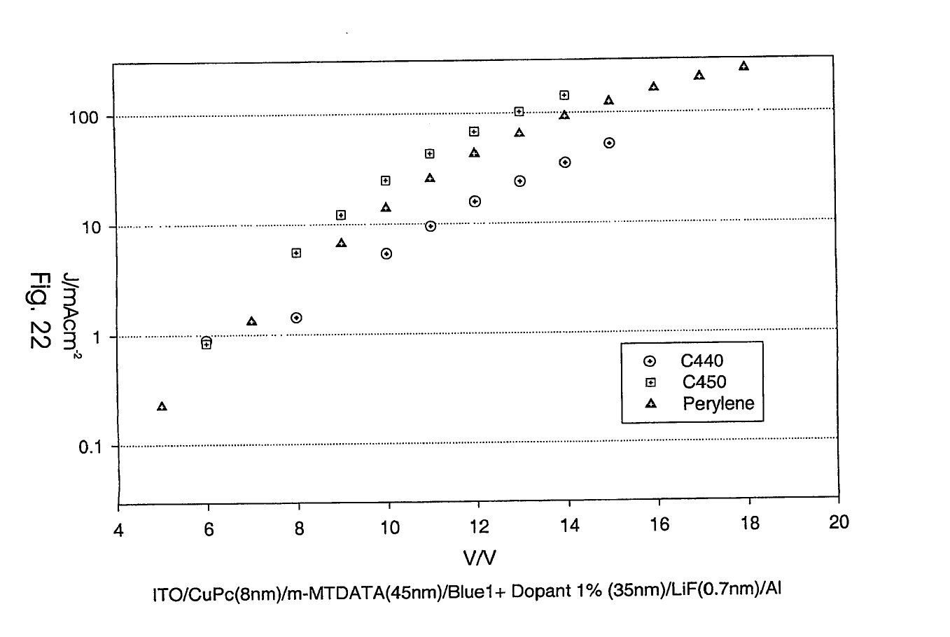

A double layer device as illustrated in FIG. 22 was constructed, the device consisted of an ITO coated glass anode (1), a copper phthalocyanine layer (2), a hole transporting layer (3), layer of the doped lithium quinolate (4), a lithium fluoride layer (5) and an aluminium cathode (6); in the device the ITO coated glass had a resistance of about 10 ohms. An ITO coated glass piece (1×1 cm²) had a portion etched out with concentrated hydrochloric acid to remove the ITO and was cleaned and dried. The device was fabricated by sequentially forming on the ITO, by vacuum evaporation at 1×10⁻⁵ Torr, a copper phthalocyanine buffer layer, a M-MTDATA hole transmitting layer and the doped lithium quinolate electroluminescent layer.

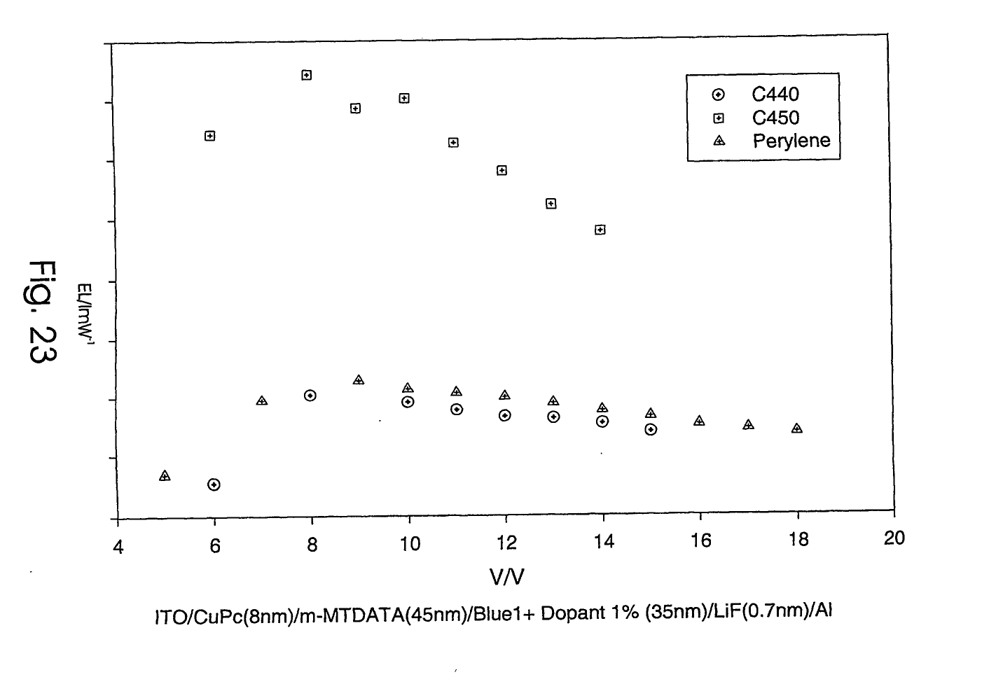

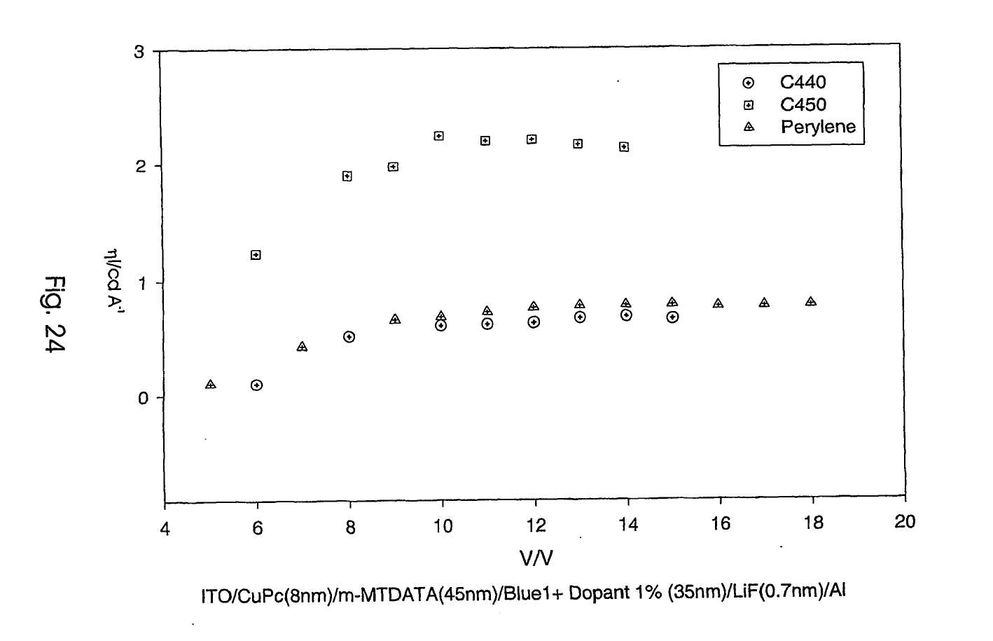

Variable voltage was applied across the device and the spectra and performance measured and the results shown in FIGS. 23 to 26.

1-41. (canceled)

42. An electroluminescent device which comprises: (i) a first electrode element; (ii) a second electrode element; and, (iii) a layer of an electroluminescent material consisting essentially of lithium quinolate doped with a dopant, said electroluminescent layer being positioned between said first and second electrode elements.

43. An electroluminescent device according to claim 42 wherein the dopant is selected from the group consisting of coumarins, coumarin derivatives, perylenes, perylene derivatives, salts of bis benzene sulphonic acid, and mixtures thereof.

44. An electroluminescent device according to claim 42 wherein the dopant is selected from the group consisting of: (a) compounds having the general chemical formula 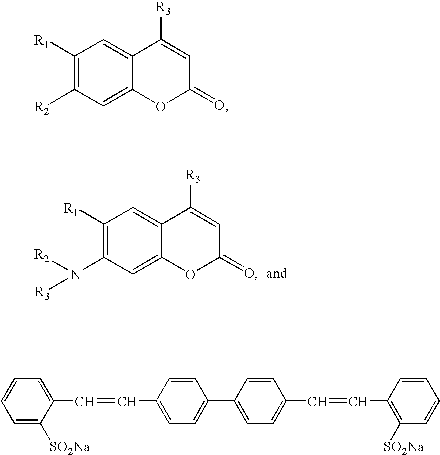
where R₁, R₂ and R₃ are selected from hydrogen or an alkyl group, or from amino or substituted amino groups; and, (b) compounds having the chemical formulas

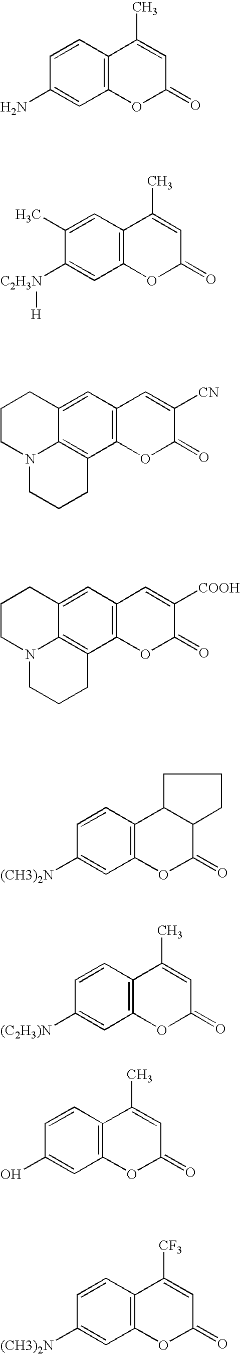

45. An electroluminescent device according to claim 42 wherein the lithium quinolate has been prepared by the reaction of a lithium alkyl or alkoxide with 8-hydroxy quinoline or substituted 8-hydroxy quinoline in a solution in a solvent consisting essentially of acetonitrile.

46. An electroluminescent device according to claim 42 wherein the lithium quinolate has been prepared by the reaction of 8-hydroxy quinoline with butyl lithium in a solvent selected from the group consisting of acetonitrile and a mixture of acetonitrile and another liquid.

47. An electroluminescent device according to claim 43 wherein the lithium quinolate has been prepared by the reaction of a lithium alkyl or alkoxide with 8-hydroxy quinoline or substituted 8-hydroxy quinoline in a solution in a solvent consisting essentially of acetonitrile.

48. An electroluminescent device according to claim 43 wherein the lithium quinolate has been prepared by the reaction of 8-hydroxy quinoline with butyl lithium in a solvent selected from the group consisting of acetonitrile and a mixture of acetonitrile and another liquid.

49. An electroluminescent device according to claim 42 wherein the dopant is selected from the group consisting of: (a) compounds having the general chemical formula (Lα)ₙM, where M is a rare earth element, or an element selected from the lanthanide or actinide series of elements, Lα is an organic complex, and n is an integer corresponding to the valence state of M; (b) compounds having the general chemical formula 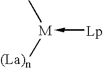
where Lα and Lp are organic ligands, M is a rare earth element, a transition metal, or an element selected from the lanthanide or actinide series of elements, and n is an integer corresponding to the valence state of the metal M, further wherein the ligands Lα can be the same or different, and Lp can be a plurality of ligands which can be the same or different; (c) compounds having the general chemical formula (Lα)ₙM₁M₂, where M₁ is a rare earth element, a transition metal, or an element selected from the lanthanide or actinide series of elements, M₂ is a non-rare earth metal, n is an integer corresponding to the combined valence state of M₁ and M₂; and, compounds having the general chemical formula (Lα)ₙM₁M₂(Lp), where M₁ is a rare earth element, a transition metal, or an element selected from the lanthanide or actinide series of elements, and M₂ is a non-rare earth metal.

50. An electroluminescent device according to claim 42 further wherein a layer of a hole transmitting material is positioned between the first electrode element and the doped lithium quinolate layer.

51. An electroluminescent device according to claim 50 wherein the hole transmitting material consists essentially of an aromatic amine complex.

52. An electroluminescent device according to claim 50 wherein the hole transmitting material consists essentially of a film of a polymer selected from the group consisting of poly(vinylcarbazole), N,N′-diphenyl-N,N′bis(3-methylphenyl)-1,1′-biphenyl-4,4′-diamine (TPD), polyaniline, substituted polyanilines, polythiophenes, substituted polythiophenes, polysilanes, substituted polysilanes, and polymers of cyclic aromatic compounds.

53. An electroluminescent device according to claim 42 further wherein a layer of a hole transmitting material is positioned between the first electrode element and the doped lithium quinolate layer, and also wherein the hole transmitting material is selected from the group consisting of aromatic amine complexes.

54. An electroluminescent device according to claim 43 further wherein a layer of a hole transmitting material is positioned between the first electrode element and the doped lithium quinolate layer, and also wherein the hole transmitting material consists essentially of a film of a polymer selected from the group consisting of poly(vinylcarbazole), N,N′-diphenyl-N,N′bis(3-methylphenyl)-1,1′-biphenyl-4,4′-diamine (TPD), polyaniline, substituted polyanilines, polythiophenes, substituted polythiophenes, polysilances, substituted polysilanes, and polymers of cyclic aromatic compounds.

55. An electroluminescent device according to claim 42 further wherein one of said first and second electrode elements is a cathode, and a layer of an electron transmitting material is positioned between the cathode and the electroluminescent material layer.

56. An electroluminescent device according to claim 55 wherein the electron transmitting material consists essentially of a metal quinolate.

57. An electroluminescent device according to claim 56 wherein the metal quinolate is an aluminium quinolate or a lithium quinolate.

58. An electroluminescent device according to claim 55 wherein the electron transmitting material consists essentially of a cyano anthracene compound.

59. An electroluminescent device according to claim 42 wherein the second electrode element is selected from the group consisting of aluminium, calcium, lithium, and silver/magnesium alloys.

60. An electroluminescent device according to claim 42 wherein the dopant is present in the lithium quinolate in an amount of about 0.001% to 20% by weight based on the weight of the lithium quinolate.

61. A composition comprising lithium quinolate having a dopant incorporated therein.

62. A composition according to claim 61 wherein the dopant is selected from the group consisting of coumarins, coumarin derivatives, perylenes, perylene derivatives, salts of bis benzene sulphonic acid, and mixtures thereof.

63. A composition according to claim 61 wherein the dopant is selected from the group consisting of: (a) compounds having the general chemical formula 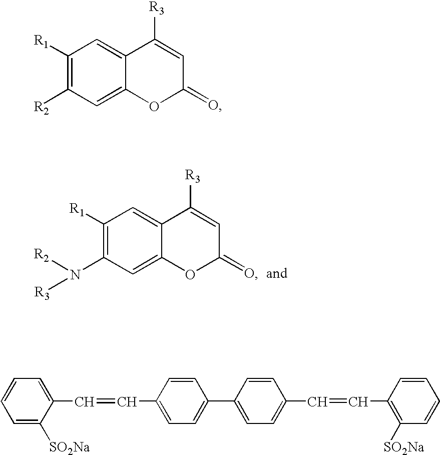
where R₁, R₂ and R₃ are selected from hydrogen or an alkyl group, or from amino or substituted amino groups; and (b) compounds having the chemical formulas

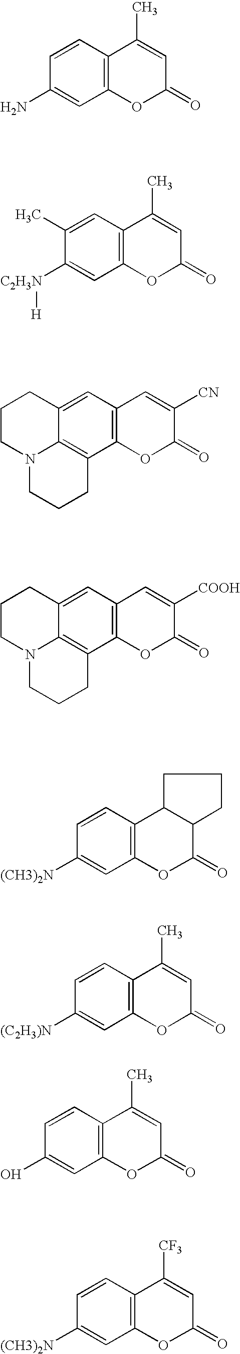

64. A composition according to claim 61 wherein the dopant is present in the lithium quinolate in an amount of about 0.001% to 20% by weight based on the weight of the lithium quinolate.
